(19) United States
(12) Patent Application Publication
(10) Pub. No.: US 2009/0055839 A1
(43) Pub. Date: Feb. 26, 2009

(54) SYSTEMS, METHODS, AND COMPUTER PRODUCTS FOR DATA ORIENTED ASPECT PROGRAMMING IN MESSAGE FLOW

(75) Inventors: Allen V. C. Chan, Markham (CA); Phil S. Coulthard, Aurora (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINE CORPORATION, Armonk, NY (US)

(21) Appl. No.: 11/842,279

(22) Filed: Aug. 21, 2007

(51) Int. Cl. G06F 9/44

(52) U.S. Cl. 719/319

(57) ABSTRACT

Systems, methods and computer products for data oriented aspect programming in message flows. Exemplary embodiments include a method including defining a set of static and dynamic rules to identify a plurality of data-oriented join points in a message flow, wherein each of the plurality of join points is a specific point in the message flow at runtime, defining a set of actions for each of the plurality of data-oriented join points, the set of actions executing once a respective join point condition of a set of static and dynamic conditions are met, inserting the set of static and dynamic rules into the message flow at each of the plurality of data-oriented join points and executing the set of actions for each one of the inserted set of static and dynamic rules in response to a respective static and dynamic condition being met.

IBM® is a registered trademark of International Business Machines Corporation. Anmonk, New York, U.S.A. Other names used herein may be registered trademarks, trademarks or product names of International Business Machines Corporation or other companies.

### BACKGROUND OF THE INVENTION

1. Field of the Invention

This invention relates to aspect oriented programming, and particularly to systems, methods and computer products for data oriented aspect programming in message flows.

2. Description of Background

Message Oriented Architecture (MOA) describes a system integration approach where applications can communicate with other applications though the exchange of messages without having to know what platform or processor the other application resides on within the network. The messages can contain formatted data, requests for action, or both. A message flow describes a controlled and directed flow of messages across a sequence of flow primitives, usually starting with the receipt of a message by an operation and ending with the return of the response from the operation or calls to an external Service partner. A flow primitive in a message flow typically represents a unit of work that must be completed before the next flow primitive or next set of flow primitives are executed. These flow primitives are used to broker messages, typically performing Junctions like routing, logging and transformation. There need be no restriction on the function of these flow primitives, but they typically act on or change the content or context (headers) of the message.

Message Flows are also used in an Enterprise Service Bus (ESB) to support Service Oriented Architecture (SOA), whereby the message is simply the payload or parameters of a Service call. However, current message flow programming model often relies on the user to define message flow statically. The user often has to go back to the original tool to change the message flow if there are any changes in business conditions. One of the advantages provided by the ESB is the use of a canonical logical Message format based on XML. By leveraging the canonical format, it enables the introduction of AOP (Aspect-Oriented Programming) to messages flow based on a set of static and dynamic data-oriented join conditions. The data for the join conditions is the content and context of the messages, as described by their canonical format.

There exists a need for applying AOP to message flow based on a set of static and dynamic data-oriented join conditions.

### SUMMARY OF THE INVENTION

Exemplary embodiments include a method for supporting dynamic changes in message flow using aspect oriented programming technique within a computing system, the method including defining a set of static and dynamic rules to identify a plurality of data-oriented join points in a message flow, wherein each of the plurality of join points is a specific point in the message flow at runtime, defining a set of actions for each of the plurality of data-oriented join points, the set of actions executing once a respective join point condition of a set of static and dynamic conditions are met, inserting the set of static and dynamic rules into the message flow at each of the plurality of data-oriented join points and executing the set of actions for each one of the inserted set of static and dynamic rules in response to a respective static and dynamic condition being met.

Further exemplary embodiments include a system for supporting dynamic changes in aspect oriented programming, the system including a processing device having a memory, a process residing in the memory having instructions for defining a set of static and dynamic rules to identify a plurality of data-oriented join points in a message flow, wherein each of the plurality of join points is a specific point in the message flow at runtime, defining a set of actions for each of the plurality of data-oriented join points, the set of actions executing once a respective join point condition of a set of static and dynamic conditions are met, inserting the set of static and dynamic rules into the message flow at each of the plurality of data-oriented join points, executing the set of actions for each one of the inserted set of static and dynamic rules in response to a respective static and dynamic condition being met and defining a message subflow containing message oriented programming.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which applies AOP to message flow based on a set of static and dynamic data-oriented join conditions.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary system for data oriented aspect programming in message flow,

FIG. 2 illustrates a flow primitive, which represents a unit of work in a message flow with input, output and fail terminals, in accordance with exemplary embodiments;

FIG. 3 illustrates a flow diagram illustrating a message flow with flow primitives wired together in accordance with exemplary embodiments;

FIG. 4 illustrates a diagram of a message subflow in accordance with exemplary embodiments; and

FIG. 5 is a flow chart of a method for data oriented aspect programming in message flow in accordance with exemplary embodiments.

The detailed description explains the preferred embodiments of the invention, together with advantages and features, by way of example with reference to the drawings.

### DETAILED DESCRIPTION OF THE INVENTION

In exemplary embodiments, the systems and methods described herein implemented data-oriented AOP to support dynamic changes to message flows at runtime. In exemplary embodiments, the systems and methods described herein implement a set of static and dynamic rules to identify data-oriented “join points” in a message flow. A “join point” is a specific point in a message flow at runtime based on static and dynamic conditions. Furthermore, the systems and methods described herein implement a flow aspect, which is a “join point”, together with a set of actions that execute once the “join point” condition is met.

Turning now to the drawings in greater detail, it will be seen that in FIG. 1 there is FIG. 1 illustrates an exemplary system for data oriented aspect programming in message flow. In exemplary embodiments, the system 100 includes a processing device 105 such as a computer, which includes a storage medium or memory 110. The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processing device 105. The system 100 can further include a data oriented aspect programming in message flow application 120 residing in the memory.

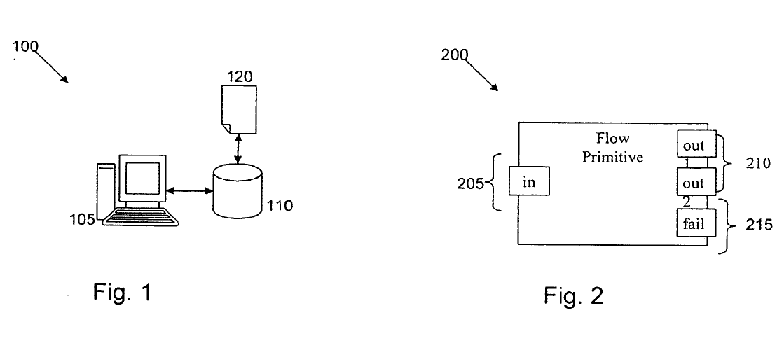

FIG. 2 illustrates a flow primitive 200, which represents a unit of work in a message flow with input, output and fail terminals, in accordance with exemplary embodiments. The flow primitive 200 executed as soon as a message reaches one of the input terminals 205. In addition, the flow primitive 200 may invoke other flow primitives by putting a message on one or more of the output terminals 210. If a flow primitive fails during its execution, its corresponding fail terminal 215 is invoked.

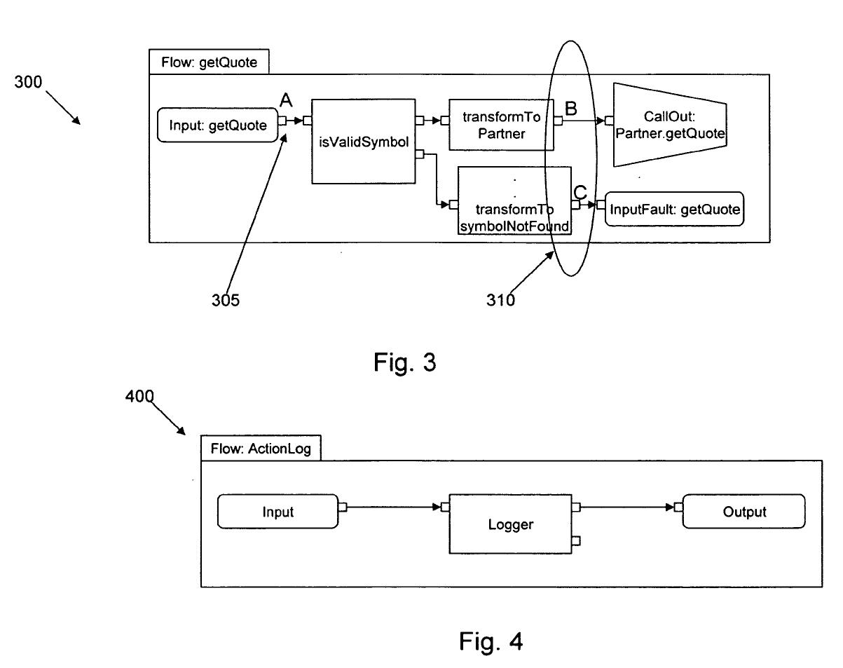

FIG. 3 illustrates a flow diagram 300 illustrating a message flow with flow primitives wired together in accordance with exemplary embodiments. The flow diagram includes a first join point 305 and a second join point 310. In exemplary embodiments, join points are associated on input, output and fail terminals for every primitives used in a flow. A Join Point is defined by a combination of the following criteria as in the following table:

| Criteria | Possible Choices/Value | Notes |
|---|---|---|
| Flow Name | Name of the flow | ‘*’ to apply to all flows |
| Primitive Type | Type of the primitive node | “*” to apply to all primitive |
| | | types |
| Primitive Name | Name of the primitive node | “*” to apply to all |
| | | primitives |
| Terminal Type | In or Out or Fail | ‘*’ to apply to all terminals |
| Terminal Name | Name of the terminal | ‘*’ to apply to all terminals |
| Message Type | Name of the message | ‘*’ to apply to all message |
| Data Filter | XPath boolean expression | Any XPath expression |
| | specifying a condition to be | evaluated to true or false. |
| | evaluated at runtime. | |

Based on the message flow programming model as illustrated by the flow diagram 300 and the use of a canonical data format, the join points 305, 310 can be qualified by providing additional selection filter such as the use of certain data types in message, the use of certain primitive types, and the existence of certain values in the message. In exemplary embodiments, an arbitrary selection filters can be inserted at the join points 305, 310 for evaluation at runtime. For example, based on the flow specified in FIG. 3, the join point 305 can be specified to select the terminal A when conditions specified in the data filter are true. In addition, the following join condition can be specified by using a simple XML based description:

```
<joinPoint name=”joinpoint1”>
    <flow>getQuote</flow>
    <primitiveType>Input</primitiveType>
    <terminalType>out</terminalType>
    <dataFilter>/headers/JMSHeader[priority=9]</dataFilter>
</joinPoint>
```

In addition, join point 310 can be specified to select both terminal B and C, the following join condition is specified:

```
<joinPoint name=”joinpoint2”>
    <flow>getQuote</flow>
    <primitiveType>Transform</primitiveType>
    <terminalType>out</terminalType>
</joinPoint>
```

In exemplary embodiments, a message flow aspect is a combination of one or more join points together with an action to be performed once one of the join points is identified. The action used in a flow aspect can be described by using another message flow (i.e. a standalone subflow). FIG. 4 illustrates a diagram 400 of a message subflow to log a message in accordance with exemplary embodiments. In exemplary embodiments the message sub-flow may have to be constrained to allow only one entry and one exit point. Furthermore, an aspect to apply to the subflow to join point 305 (FIG. 3) can be defined as follows:

```
<aspect name=”aspect1”>
    <joinPoint>joinPoint1</joinPoint>
    <flow name=”ActionLog”>
            <property name=”abc”>xyz</property>
            <property name=”def”>123</property>
    </flow>
    <priority>1</priority>
</aspect>
```

Based on the above definition, any time the condition specified in join point 305 is satisfied, the flow ActionLog is executed based on the priority sequence specified in this aspect when compared to other aspects that may also be invoked. Other uses of flow aspects are common error handling or logging for governance purposes.

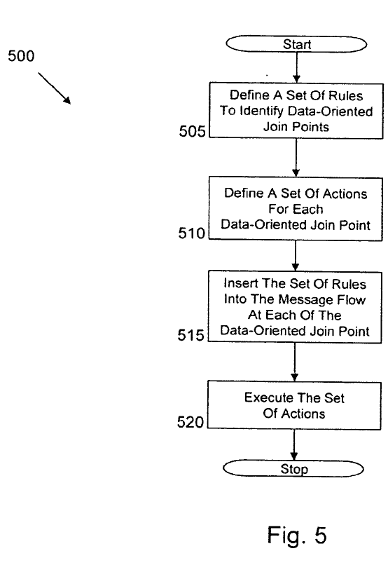

FIG. 5 is a flow chair of a method 500 for data oriented aspect programming in message flow in accordance with exemplary embodiments. At step 505, the method 500 defines a set of static and dynamic rules to identify data-oriented join points in a message flow. In exemplary embodiments, each of the join points is a specific point in the message flow at runtime based on a set of static and dynamic conditions. At step 510, the method 500 defines a set of actions for each of the data-oriented join points. In exemplary embodiments, the flow aspect join point has a set of actions that execute once a respective join point condition of the set of static and dynamic conditions is met. At step 515, the method 500 inserts the set of static and dynamic rules into the message flow at each of the data-oriented join points. At step 520, the method 500 executes the set of actions for each one of the inserted set of static and dynamic rules in response to a respective static and dynamic condition being met.

In exemplary embodiments, a message flow meta-aspect is an aspect that can be applied on top of an existing aspect. A meta-aspect is used to handle exception condition of a regular aspect. Depending on the programming model, a meta-aspect may not be applied to another meta-aspect. Furthermore, in exemplary embodiments, a message flow aspect should a separately installable entity to any message flow runtime, which allows the system administrator to turn on/off an aspect based on business needs. In exemplary embodiments, once a message flow aspect is deployed, it is registered with the runtime flow engine. Initially, static conditions are evaluated to scope down the set of possible aspects for any given flow. During message flow execution, each potential aspect is evaluated against the runtime canonical logical message format. Once a join point condition is matched, the flow specified in the aspect is executed.

As such, it is appreciated that by applying the described mechanism to the message flow programming model, dynamic on-demand modification of message flow at runtime based on a data-oriented aspect programming model is supported.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method for supporting dynamic changes in message flow using aspect oriented programming technique within a computing system, the method consisting of:
defining a set of static and dynamic rules to identify a plurality of data-oriented join points in a message flow, wherein each of the plurality of data-oriented join points is a specific point in the message flow at runtime;
defining a set of actions for each of the plurality of data-oriented join points, the set of actions executing once a respective join point condition of a set of static and dynamic conditions are met;
inserting the set of static and dynamic rules into the message flow at each of the plurality of data-oriented join points;
executing the set of actions for each one of the inserted set of static and dynamic rules in response to a respective static and dynamic condition being met;
defining a message subflow containing message oriented programming,
wherein the message subflow allows only one entry point an only one exit point,
wherein the message subflow logs and defines a message associated with a message flow of the set of actions for each one of the inserted set of static and dynamic rules,
wherein the message oriented programming includes at least one of encryption, decryption and policy validation,
wherein the message flow includes a message flow aspect that is a separately installable entity to a message flow runtime, wherein the message flow aspect is registered when the message flow aspect is deployed, wherein a plurality of static conditions are evaluated to scope down a set of possible aspects for the message flow, wherein each potential aspect is evaluated against a runtime canonical logical message format; and
executing the message flow specified in the message flow aspect when each of the plurality of data-oriented join points is matched.

2-4. (canceled)

5. A system for supporting dynamic changes in aspect oriented programming, the system comprising:
a processing device having a memory;
a process residing in the memory having instructions for:
defining a set of static and dynamic rules to identify a plurality of data-oriented join points in a message flow, wherein each of the plurality of data-oriented join points is a specific point in the message flow at runtime;
defining a set of actions for each of the plurality of data-oriented join points, the set of actions executing once a respective join point condition of a set of static and dynamic conditions are met;
inserting the set of static and dynamic rules into the message flow at each of the plurality of data-oriented join points;
executing the set of actions for each one of the inserted set of static and dynamic rules in response to a respective static and dynamic condition being met; and
defining a message subflow containing message oriented programming,
wherein the message subflow allows only one entry point an only one exit point,
wherein the message subflow logs and defines a message associated with a message flow of the set of actions for each one of the inserted set of static and dynamic rules,
wherein the message oriented programming includes at least one of encryption, decryption and policy validation,
wherein the message flow includes a message flow aspect that is a separately installable entity to a message flow runtime, wherein the message flow aspect is registered when the message flow aspect is deployed, wherein a plurality of static conditions are evaluated to scope down a set of possible aspects for the message flow, wherein each potential aspect is evaluated against a runtime canonical logical message format; and
executing the message flow specified in the message flow aspect when each of the plurality of data-oriented join points is matched.
